(19) United States
(12) Patent Application Publication
(10) Pub. No.: US 2005/0185077 A1
(43) Pub. Date: Aug. 25, 2005

(54) CMOS IMAGE SENSOR WITH 1.25 - 1.5 TRANSISTOR/PIXEL RATIO

(75) Inventor: Peter H. Xiao, Santa Clara, CA (US)

Correspondence Address: SQUIRE, SANDERS & DEMPSEY L.L.P, 600 HANSEN WAY, PALO ALTO, CA, 94304-1043, US

(73) Assignee: JPS Group Holdings, Ltd., Tortola (VG)

(21) Appl. No.: 10/904,526

(22) Filed: Nov. 15, 2004

Related U.S. Application Data
(60) Provisional application No. 60/546,882, filed on Feb. 23, 2004.

(51) Int. Cl. H04N 5/335; H04N 3/14

(52) U.S. Cl. 348/302

(57) ABSTRACT

An image sensor includes an imaging region having a 1.25 or 1.5 transistor per pixel ratio. The 1.5 transistor/pixel imaging region includes two pairs of pixels, the first pair arranged in parallel and the second pair arranged in an offset arrangement. The pixels share a read out and reset transistor. The 1.25 transistor/pixel imaging region includes 2 blocks of 4 pixels arranged in parallel that share a read out and reset transistor.

### PRIORITY REFERENCE TO PRIOR APPLICATIONS

This application claims benefit of and incorporates by reference U.S. patent application Ser. No. 60/546,882, entitled “ACTIVE PIXEL WITH REDUCED NUMBER OF TRANSISTORS,” filed on Feb. 23, 2003, by inventor Peter Xiao.

### TECHNICAL FIELD

This invention relates generally to digital image sensors, and more particularly, but not exclusively, provides a digital complementary metal oxide semiconductor (CMOS) image sensor with layouts that reduce the number of transistors per pixel over conventional image sensors.

### BACKGROUND

CMOS image sensors are used in digital cameras, wireless phones and other electronic devices. The sensors convert light into electrons, which are then converted into digital values for further processing, display, storage, and/or transmission.

Conventional CMOS image sensors include a plurality of pixels for capturing light and converting the light to electrons. Specifically, each pixel includes a photodiode to collect the light and several transistors (e.g., 4) for reset and voltage readout. The area of the photodiode is important because it will determine the amount light capable of being captured. The ratio of photodiode area over the entire pixel area is known as the fill area and it is desirable to increase the fill area to increase the amount of light capable of being captured per pixel, which will increase image sensor resolution and enable smaller digital camera designs.

However, fill area is negatively effected in CMOS image sensors by the need to have several transistors per pixel. Some designs have been shown, such as the image sensors imaging regions 200 and 300 of FIG. 2 and FIG. 3, respectively, to increase fill area by sharing transistors among pixels, thereby bringing down the transistor/pixel value to as low as 1.5 transistors/pixel. However, the image sensor imaging region 200 includes a long sense line, which leads to charge attenuation, while the image sensor imaging region 300 provides a congested geometry since each pixel needs a separate row, making the image sensor imaging region 300 tough to layout.

Accordingly, new CMOS imaging sensors are needed that decrease the transistor/pixel value and ease congestion to improve layout.

### SUMMARY

Embodiments of the invention enable a reduced transistor/pixel ratio; less congestion, which eases layout; and a shorter sense line that reduces charge dissipation (which can reduce the signal to noise ratio).

In one embodiment, a CMOS image detector includes an imaging region having a 1.5 transistor/pixel ratio and comprises a first and a second pair of pixels, wherein each pixel including a photodiode and a transistor communicatively coupled together; a reset transistor communicatively coupled to each transistor in each pixel; and a readout transistor communicatively coupled to each transistor in each pixel. The first pair of pixels is aligned in parallel about a first axis and the second pair of pixels are offset against each other across a second axis that is substantially perpendicular to the first axis.

In another embodiment of the invention, a CMOS image detector including an imaging region having a 1.25 transistor/pixel ratio and comprises two blocks of four pixels each, the blocks aligned in parallel relative to an axis between the two blocks, each pixel including a photodiode and a transistor coupled together; a reset transistor communicatively coupled to each transistor in each pixel; and a readout transistor communicatively coupled to each transistor in each pixel.

In an embodiment of the invention, a method comprises: providing one of the CMOS image detectors described above; charging each transistor in each pixel;
exposing each photodiode to light; reading out each transistor in each pixel; digitizing the read out values; and storing the digitized values in memory.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating an image sensor in accordance with an embodiment of the present invention;

FIG. 2 is a diagram illustrating a prior art image sensor imaging region;

FIG. 3 is a diagram illustrating another prior art image sensor imaging region;

FIG. 4 is a diagram illustrating an image sensor imaging region according to an embodiment of the invention;

FIG. 5 is a diagram illustrating an image sensor imaging region according to another embodiment of the invention; and

FIG. 6 is a flowchart illustrating a method of image sensing.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

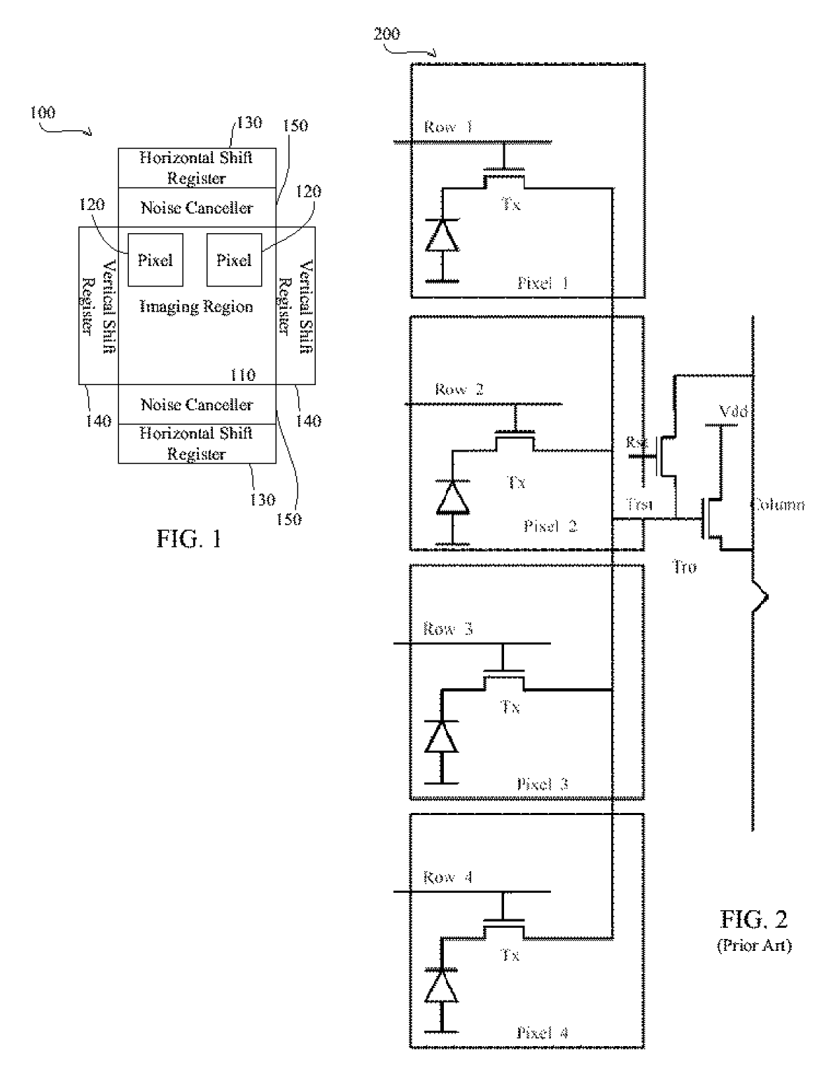

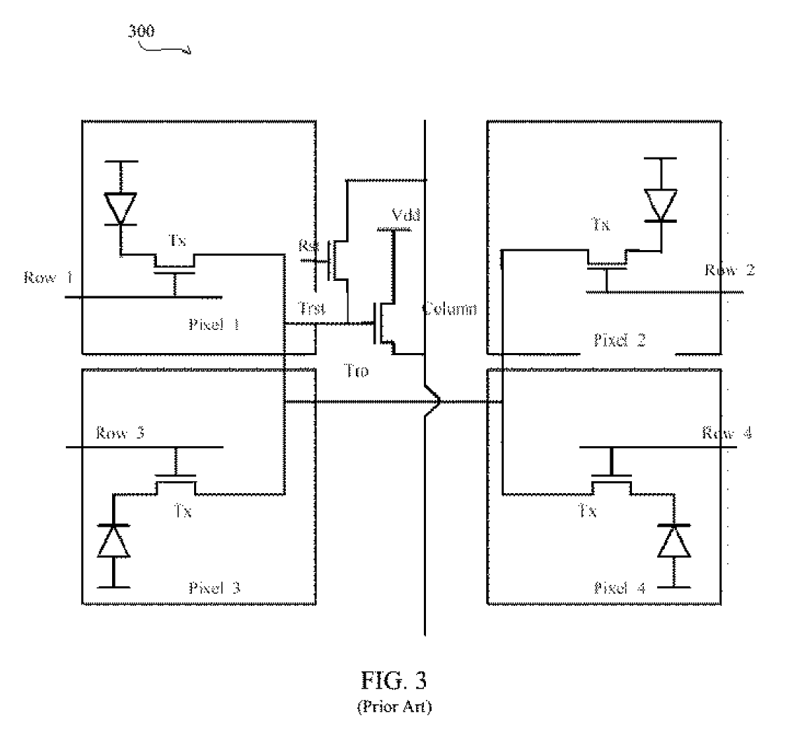

FIG. 1 is a block diagram illustrating an image sensor 100 in accordance with an embodiment of the present invention. The image sensor includes an imaging region 110 that includes a plurality of pixels 120. It will be appreciated by one of ordinary skill in the art that only 2 pixels 120 are shown for ease of illustration and that the imaging region 110 can include thousands (or more) pixels 120. The images sensor 110 also includes noise cancellers 150 communicatively coupled to the imaging region 110 that reduce noise generated by the imaging region 110 as CMOS sensors tend to generate more noise than CCD sensors. The imaging sensor 110 also includes registers, such as the horizontal shift registers 130 and the vertical shift registers 140, which are communicatively coupled to the imaging region 110 and/or the noise cancellers 150. The registers 130 and 140 store digitized values read out from the pixels 120 (optionally after noise filtering by the noise cancellers 150).

During operation of the imaging sensor 100, pixels 120 in the imaging region 110, after charging, receive light and transform the light into electrons as indicated by changing voltage levels in photodiodes of the pixels 120. Transistors in and out of the pixels 120 then read the voltage change and the noise cancellers 150 filter out noise from the read out values. The values are then digitized by an analog to digital converter (ADC) (not shown) and stored in the registers 130 and 140 for further processing, display, and/or transmission.

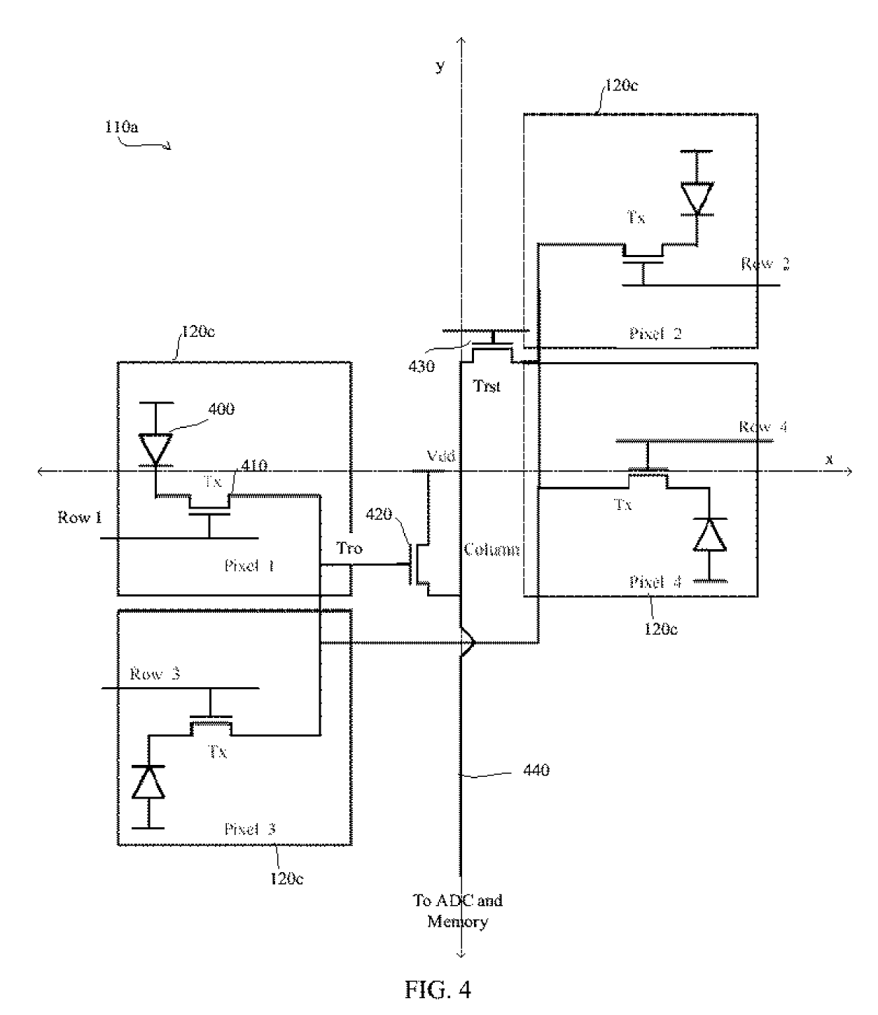

FIG. 4 is a diagram illustrating an image sensor imaging region 110a according to an embodiment of the invention. The imaging region 110a includes four pixels 120c, which are substantially identical to each other and share transistors, giving the imaging region 110a a 1.5 transistor per pixel ratio. Each pixel 120c includes a photodiode 400 communicatively coupled to a transistor 410, which is communicatively coupled to a shared readout transistor 420 and a shared reset transistor 430. The readout transistor 420 and the reset transistor 430 are communicatively coupled to a sense line 440, which is communicatively coupled to other devices, such as an ADC and memory.

The sense line 440 travels vertically between two pairs of two pixels 120c (i.e., pixels 1 and 3 are to left of the sense line 440 at rows 1 and 3 while the pixels 2 and 4 are to the right of the sense line 440 at rows 2 and 4) along a first (vertical) axis. The pixels 1 and 3 are arranged in a staggered, offset, or stepped relationship with respect to the pixels 2 and 4. That is, pixel 1 is aligned in parallel with the pixel 4 across the first axis, while pixel 2 is located above pixel 4 and pixel 3 is located beneath pixel 1. The pixels 2 and 3 are offset relative to each other across a second (horizontal) axis perpendicular to the first axis.

In an embodiment of the invention, pixels 2 and 4 are separated by a distance shorter than the distance between pixels 1 and 4. Similarly, pixels 1 and 3 are separated from each other by a shorter distance than the distance between the pixels 1 and 4. The distances between pixels 1 and 3 and pixels 2 and 4 can be substantially equal. The ratio of the distances between the two pairs of pixels can range from about 2:1 to about 10:1.

In another embodiment of the invention, the pixels 1 through 4 form a set of pixels and the imaging region 110a comprises a plurality of sets of pixels arranged in an interlocking pattern of steps.

During operation of the imaging region 110a, the photodiodes 400 in each pixel 120c is exposed to light and convert the light to electrons as indicated by a change in voltage recorded by the transistor 410. The readout transistor 420 then reads out the transistors 410 from each pixel 120c sequentially and feeds the read out data down the sense line 440 to other circuitry. The reset transistor 430 then resets the transistors 410 in each pixel 120c.

The advantages of the layout of imaging region 110a is that it achieves a transistor per pixel ratio of 1.5 while enabling a more even distribution of rows, which makes it easier to do layout as compared to the imaging region 300. In addition, the layout of the imaging region 110a is less congested and cuts down the row select wiring in each sharing area by a factor of two. The shared transistors (the readout transistor 420 and the reset transistor 430) can also be more uniformly distributed among the sharing area. Accordingly, photodiode area is maximized, thereby increasing the fill area. Further, the sense line 440 is shorter than the sense line of the imaging region 200, thereby leading to less charge attenuation.

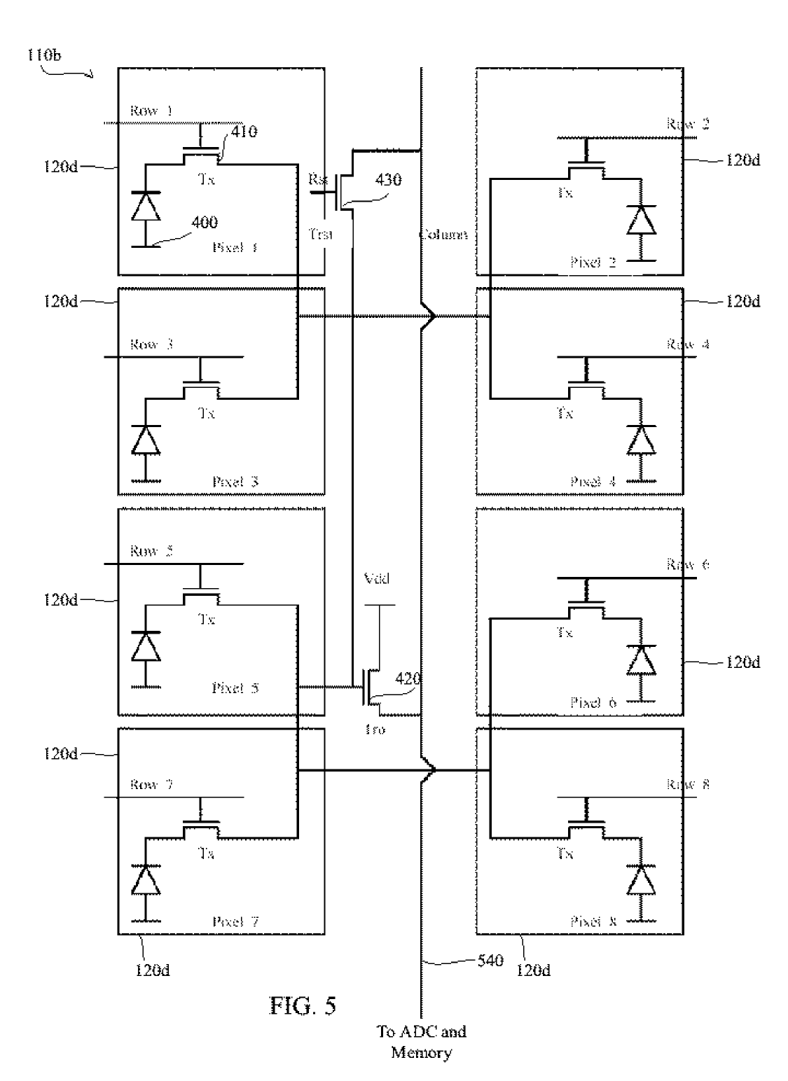

FIG. 5 is a diagram illustrating an image sensor imaging region 110b according to another embodiment of the invention. The imaging region 110b includes eight pixels 120d, which are substantially identical to each other and share transistors, giving the imaging region 110b a 1.25 transistor per pixel ratio. Each pixel 120d includes a photodiode 400 communicatively coupled to a transistor 410, which is communicatively coupled to a shared readout transistor 420 and a shared reset transistor 430. The readout transistor 420 and the reset transistor 430 are communicatively coupled to a sense line 540, which is communicatively coupled to other devices, such as an ADC and memory.

The imaging region 110b includes two neighboring blocks of four pixels 120d each aligned in parallel from each other across the sense line 540, thereby achieving a 1.25 transistor per pixel ratio. In an embodiment of the invention, the sense line 540 runs in parallel with a vertical axis between the two neighboring blocks of four pixels 120d. The two blocks can be arranged in horizontally or vertically. In a vertical embodiment, layout congestion is reduced and the eight pixels 120d have eight row select lines and one column line.

During operation of the imaging region 110b, the photodiodes 400 in each pixel 120d is exposed to light and convert the light to electrons as indicated by a change in voltage recorded by the transistor 410. The readout transistor 420 then reads out the transistors 410 from each pixel 120c sequentially and feeds the read out data down the sense line 540 to other circuitry. The reset transistor 430 then resets the transistors 410 in each pixel 120d.

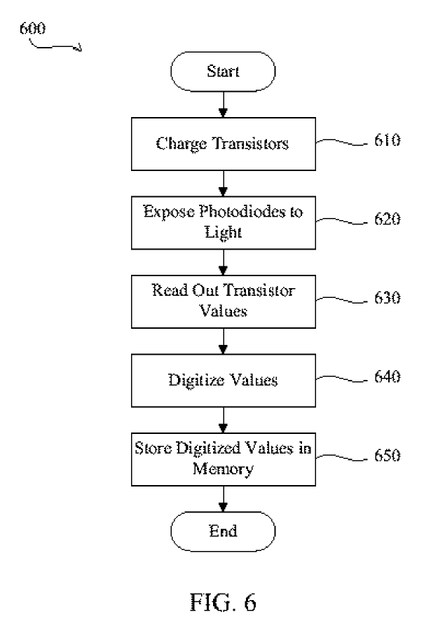

FIG. 6 is a flowchart illustrating a method 600 of image sensing using the imaging regions 110a and/or 110b. First, the reset transistor 430 charges (610) the transistors 410 in each pixel 120c or 120d. Next, the photodiodes are exposed (620) to light. The readout transistor 420 then reads out (630) the values in the transistors 410 in sequential order (or substantially simultaneously or in any other order). The values are then digitized (640) by an ADC and the digitized values are stored (650) in memory, e.g., the registers 130 and 140. The method 600 then ends. In an embodiment of the invention, noise cancellation can also be performed before storing (650) the digitized values in memory.

The foregoing description of the illustrated embodiments of the present invention is by way of example only, and other variations and modifications of the above-described embodiments and methods are possible in light of the foregoing teaching. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A CMOS image detector having an imaging region comprising:
a first and a second pair of pixels, each pixel including a photodiode and a transistor communicatively coupled together;
a reset transistor communicatively coupled to each transistor in each pixel; and
a readout transistor communicatively coupled to each transistor in each pixel;
wherein the first pair of pixels is aligned in parallel about a first axis and the second pair of pixels are offset against each other across a second axis that is substantially perpendicular to the first axis.

2. The CMOS image detector of claim 1, wherein the reset and readout transistors are communicatively coupled to a sense line substantially aligned in parallel with the first axis.

3. The CMOS image detector of claim 2, wherein the sense line is communicatively coupled to an analog to digital converter.

4. The CMOS image detector of claim 1, wherein the first and second pairs of pixels form a set of pixels and wherein the imaging region further comprises a plurality of sets of pixels arranged in an interlocking pattern of steps.

5. A digital camera incorporating the CMOS image detector of claim 1.

6. A CMOS image detector having an imaging region with a transistor per pixel ratio of 1.25.

7. The CMOS image detector of claim 6, wherein the imaging region comprises:
two blocks of four pixels each, the blocks aligned in parallel relative to an axis between the two blocks, each pixel including a photodiode and a transistor coupled together;
a reset transistor communicatively coupled to each transistor in each pixel; and
a readout transistor communicatively coupled to each transistor in each pixel.

8. The CMOS image detector of claim 7, wherein the reset and readout transistors are communicatively coupled to a sense line substantially aligned in parallel with the axis and that runs between the two blocks.

9. The CMOS image detector of claim 8, wherein the sense line is communicatively coupled to an analog to digital converter.

10. A digital camera incorporating the imaging region of claim 6.

11. A method, comprising:
providing a CMOS image detector having an imaging region, the imaging region comprising
a first and a second pair of pixels, each pixel including a photodiode and a transistor communicatively coupled together;
a reset transistor communicatively coupled to each transistor in each pixel; and
a readout transistor communicatively coupled to each transistor in each pixel;
wherein the first pair of pixels is aligned in parallel about a first axis and the second pair of pixels are offset against each other across a second axis that is substantially perpendicular to the first axis;
charging each transistor in each pixel;
exposing each photodiode to light;
reading out each transistor in each pixel;
digitizing the read out values; and
storing the digitized values in memory.

12. The method of claim 11, wherein the reset and readout transistors are communicatively coupled to a sense line substantially aligned in parallel with the first axis and that runs between the two blocks.

13. The method of claim 12, wherein the sense line is communicatively coupled to an analog to digital converter.

14. The method of claim 11, wherein the first and second pair of pixels forms a set of pixels and wherein the imaging region further comprises a plurality of sets of pixels arranged in an interlocking pattern of steps.

15. A method, comprising:
providing a CMOS image detector having an imaging region with a transistor per pixel ratio of 1.25
charging each transistor in each pixel;
exposing each photodiode to light;
reading out each transistor in each pixel;
digitizing the read out values; and
storing the digitized values in memory.

16. The method of claim 15, wherein the imaging region comprises:
two blocks of four pixels each, the blocks aligned in parallel relative to an axis between the two blocks, each pixel including a photodiode and a transistor coupled together;
a reset transistor communicatively coupled to each transistor in each pixel; and
a readout transistor communicatively coupled to each transistor in each pixel.

17. The method of claim 16, wherein the reset and readout transistors are communicatively coupled to a sense line substantially aligned in parallel with the axis.

18. The method of claim 17, wherein the sense line is communicatively coupled to an analog to digital converter.
